(19) United States
(12) Patent Application Publication
(10) Pub. No.: US 2016/0257578 A1
(43) Pub. Date: Sep. 8, 2016

(54) RESIN-MADE POROUS PARTICLES AND WATER TREATMENT PROCESS USING SAME

(71) Applicant: CHIYODA CORPORATION, Yokohama-shi (JP)

(72) Inventors: Zhixiong You, Yokohama-shi (JP); Yoichi Umehara, Yokohama-shi (JP); Masayo Shinohara, Yokohama-shi (JP); Kazushige Kawamura, Yokohama-shi (JP); Takeshi Minami, Yokohama-shi (JP)

(21) Appl. No.: 15/024,585

(22) PCT Filed: Jul. 15, 2014
(86) PCT No.: PCT/JP2014/068840

§ 371 Date: May 24, 2016

(30) Foreign Application Priority Data
Sep. 26, 2013 (JP) 2013-199473

(51) Int. Cl. C02F 1/28; B01J 20/26

(52) U.S. Cl. CPC C02F 1/285; B01J 20/267; B01J 20/261; C02F 2101/32

(57) ABSTRACT

Disclosed herein is a water treatment process for efficiently removing oils from oil-containing water.

The water treatment process is a method for treating oil-containing water, comprising the steps of: preparing an oil-adsorbing material that is made of a lipophilic resin such as a pyridine resin and that has many pores in its surface and bears hydrophilic groups on an inner surface of the pores; and bringing oil-containing water into contact with the surface of the oil-adsorbing material. The step of preparing an oil-adsorbing material includes the step of converting some of hydrophobic groups, such as nitrogen-containing aromatic rings, on the inner surface of the pores to hydrophilic groups such as quaternized amine or sulfonic acid.

### TECHNICAL FIELD

The present invention relates to resin-made porous particles that can efficiently adsorb oil components contained in water to be treated and a water treatment process using the same.

### BACKGROUND ART

Waste water discharged from chemical plants or produced water extracted from crude oil and natural gas extraction sites contains organic components typified by oils. These organic components can be classified into hydrophilic (water-soluble) ones and lipophilic (hydrophobic) ones. Both types of the organic components are often removed by resin adsorption because they may cause environmental damage when directly released. For example, Patent Literature 1 discloses a technique in which hydrophobic oil components contained in waste water, such as benzene, toluene, and xylene, are extracted and removed using a porous polymer (MPPE) that is produced by kneading a polymer such as polyethylene or polypropylene with a lipophilic extractant such as castor oil and that contains a large amount of the lipophilic extractant.

Further, Patent Literature 2 discloses a technique in which oil components are removed by aeration or adsorption to activated clay from produced water from which oil components have been separated in a knockout vessel, and then water-soluble oil components, such as C6+ carboxylic acids and phenols, that cannot be removed by such treatment are removed by adsorption to commercially-available polyvinylpyridine resin particles.

### CITATION LIST

### Patent Literature

### Patent Literature 1: EP 0653950 B

Patent Literature 2: U.S. Pat. No. 5,922,206

### SUMMARY OF INVENTION

### Technical Problem

Oils can be removed to some extent by the above-described technique disclosed in Patent Literature 1 or Patent Literature 2, but are hard to be efficiently adsorbed. Further, MPPE is produced by melting a polymer and then kneading the polymer with an extractant, and therefore it is impossible for MPPE to have a cross-linked resin structure and therefore to achieve sufficient strength and durability. In addition, MPPE contains a large amount of an extractant, and therefore it is difficult to avoid a problem that secondary pollution occurs due to the leakage of the extractant during the use of MPPE. Further, the above-described polymer generally has only hydrophobic groups, which makes it difficult for water to be treated to enter the pores of porous particles made of this polymer. Therefore, the contact efficiency of the porous particles with oils dispersed in the water to be treated is low. In light of the above circumstances, it is an object of the present invention to provide a water treatment process for efficiently removing oils from oil-containing water.

### Solution to Problem

In order to solve the above issue, a water treatment process of the present invention includes the steps of: preparing an oil-adsorbing material that is made of a lipophilic resin and that has many pores in its surface and bears hydrophilic groups on an inner surface of the pores; and bringing oil-containing water into contact with the surface of the oil-adsorbing material. Further, porous particles of the present invention are made of a lipophilic resin and has many pores in their surface, the porous particles having hydrophilic groups on an inner surface of the pores.

### Advantageous Effects of Invention

According to the present invention, it is possible to efficiently remove oils from oil-containing water.

### BRIEF DESCRIPTION OF DRAWINGS

FIG. 1 illustrates reaction formulas of quaternization (a) and sulfonation (b) of a pyridine resin.

FIG. 2 is a schematic partial sectional view that illustrates the inside of pore of a porous particle according to the present invention.

FIG. 3 is a schematic view of an adsorption test device used in Examples, which uses a column filled with porous particles.

FIG. 4 is a graph obtained in Examples, which shows the relationship between the degree of quaternization (%) of hydrophobic groups in a resin and the adsorption capacities of the resin for phenol and toluene (kg/m³-resin).

FIG. 5 is a graph obtained in Examples, which shows the relationship between the cumulative supply (mL) of methanol used as a regeneration solution and the concentrations (ppm by mass) of phenol and toluene contained in discharged methanol.

### DESCRIPTION OF EMBODIMENTS

In course of the development of a resin for produced water treatment, the present inventors have found that soluble oil components (using, for example, phenol) and insoluble oil components (using, for example, toluene) contained in produced water can be removed at the same time by a copolymer resin of vinylpyridine, ethyl vinylbenzene, and divinylbenzene (hereinafter, also referred to as vinylpyridine resin or simply pyridine resin). Based on this finding, the present inventors have further studied, and as a result have found that the adsorption capacities of the copolymer resin for soluble (water-soluble) oil components and insoluble (hydrophobic) oil components are increased by quaternizing some of pyridine groups contained in the copolymer resin with MeI (methyl iodide) or the like or by sulfonating some of phenyl groups contained in the copolymer resin with concentrated sulfuric acid or the like.

The present inventors have assumed that the reason why such a remarkable effect is obtained is as follows. The pyridine resin is hydrophobic, and therefore a hydrophobic environment is created in the pores of porous particles made of the polyvinylpyridine resin, which makes it difficult for soluble oil components, such as phenol, dissolved in water to be treated and insoluble oil components, such as toluene, dispersed in the water to be treated to reach the inside of pores of the resin particles. Therefore, only adsorption sites present on the outer surface of the particles can virtually contribute to the absorption of oil components.

On the other hand, quaternization or sulfonation of some of hydrophobic groups typified by pyridine groups or phenyl groups makes it possible to introduce hydrophilic functional groups onto the inner surface of the pores so that the hydrophilic groups converted from the hydrophobic groups coexist with the hydrophobic groups (lipophilic groups) that are naturally present. As a result, the resin can have both hydrophobic and hydrophilic functions, which makes it easy for water to be treated to enter the inside of pores of the resin particles in spite of the fact that the pyridine resin is hydrophobic. Therefore, not only the surface of the particles but also the inner surface of the pores can contribute to the adsorption of oil components.

Further, the pyridine resin obtained by copolymerization and having a cross-linked structure has high heat resistance and high organic solvent resistance, and therefore can stably adsorb soluble oil components and dispersible oil components contained in water to be treated. In addition, an organic solvent such as a lower alcohol can be used as a regenerating solution to regenerate the saturated resin, which makes it very easy to perform regeneration treatment. Therefore, water to be treated that is continuously discharged can be continuously treated by, for example, providing, in parallel, two adsorption towers filled with porous particles made of the pyridine resin and switching back and forth between adsorption operation and regeneration operation.

A method for producing porous particles made of the vinylpyridine resin is not particularly limited. For example, porous particles made of the vinylpyridine resin can be produced by a method in which an oil medium containing a vinylpyridine monomer, a styrene monomer, a cross-linking agent, a porous agent, and a polymerization initiator and an aqueous medium are mixed to perform suspension polymerization of the vinylpyridine monomer. If necessary, the aqueous medium may contain appropriate amounts of dispersant (suspension stabilizer), surfactant, radical scavenger, specific gravity adjuster, pH adjuster, etc. These oil medium and aqueous medium are mixed in a polymerization reactor, and the temperature of the resulting mixture is slowly increased to perform polymerization at 50° C. to 80° C. to obtain a polymer, and is further increased to perform heat treatment at 85° C. to 95° C. so that porous particles made of the vinylpyridine resin and having an outer diameter of about 0.1 to 2 mm can be produced.

Here, the porous agent refers to a solvent that dissolves a monomer but is hard to dissolve a polymer obtained by polymerizing the monomer. Examples of the porous agent include organic solvents having the property of swelling a cross-linked copolymer and non-swelling organic solvents. When particles made of the vinylpyridine resin are synthesized by suspension polymerization, phase separation occurs between the polymer and the porous agent fed together with the monomer so that a plurality of microgels having a cross-linked network structure and a size of 0.10 to 100 μm are formed. The size of the microgels, fusion between the microgels, or the distribution of the organic solvent in gaps between the microgels is significantly influenced by compatibility between the microgels and the porous agent.

The compatibility between the vinylpyridine polymer and a solvent used as the porous agent is adjusted by using in combination poor and good solvents for the vinylpyridine polymer so that the deposition of microgels and fusion between the deposited microgels via the monomer in the solvent can be regulated. Here, the phrase “using in combination” means that, in the case of the porous agent, two or more porous agents are mixed and used for suspension polymerization, and that, in the case of the polymerization initiator that will be described later, two or more polymerization initiators are mixed and used for suspension polymerization. The two or more porous agents or polymerization initiators may be previously mixed before use or may be mixed in the reactor by stirring or the like.

The compatibility between the vinylpyridine polymer and a solvent used as the porous agent depends on their polarities. The degree of compatibility is higher when the polarities are closer to each other. As a measure of solubility, solubility parameter (SP) is used which is expressed by the square root of cohesive energy density representing intermolecular binding force. Here, when an absolute value of the difference between the SP of the vinylpyridine polymer (19 MPa^{1/2}) and the SP of a solvent is 2 or less, the solvent is defined as a good solvent, and when the absolute value is larger than 2, the solvent is defined as a poor solvent. Examples of such a good solvent include trimethylbenzene, toluene, xylene, and 2-ethylhexanol. Examples of such a poor solvent include dioctyl phthalate, octane, and nonane.

As a result of a study conducted by the present inventors, it is considered that a vinylpyridine resin having desired characteristics can be obtained by the following action. When only a poor solvent is used as the porous agent, phase separation immediately occurs between the polymer formed by polymerization of the monomer and the solvent, and therefore relatively-small microgels are first deposited. The deposited microgels take in the unreacted monomer that is highly compatible, and are fused together to grow to relatively large microgels.

At this time, gaps between the microgels are clogged with the monomer that has been taken in, and therefore large pores derived from gaps between the large microgels are developed in a finally-obtained resin. The thus obtained resin has a small contact area between the microgels, a small specific surface area, and a small pore volume due to the development of large pores.

On the other hand, when only a good solvent is used as the porous agent, phase separation between the polymer and the solvent is less likely to occur, and therefore microgels are not deposited until they grow to a certain size. At this time, the amount of the monomer remaining in the solvent is small. Further, the monomer is uniformly distributed between the good solvent and the microgels, and therefore fusion between the depositedmicrogels via the monomer hardly occurs, and as a result, only micro pores derived from the good solvent uniformly dispersed in gaps between the microgels are formed. Thus, a finally-obtained resin has small pores, and therefore cannot achieve a satisfactory substance diffusion rate.

On the other hand, phase separation between the polymer and the solvent can be regulated by using in combination a poor solvent and a good solvent. Specifically, the size of microgels to be deposited and fusion between the deposited microgels via the monomer contained in the solvent are regulated, and therefore large microgels are not developed unlike the case where only a poor solvent is used, and a resin comprising relatively-small microgels densely joined together can be obtained.

At this time, the good solvent is highly compatible with the microgels, and part of the good solvent is distributed in the microgels to solvate their framework. The mixture of the remaining good solvent and the poor solvent is uniformly dispersed in gaps between the microgels. Therefore, the gaps between the microgels are not completely clogged with the monomer, and pores having an appropriate diameter are uniformly formed in the entire resin by removing the good solvent and the poor solvent after the resin is formed.

In this way, a macroporous resin can be obtained in which microgels are densely joined together while pores having an appropriate size and derived from gaps between the microgels remain. This macroporous resin comprises relatively-small microgels densely joined together, and therefore porous particles having a high specific surface area and a large pore volume can be obtained.

The composition of the porous agent varies depending on the properties of the good solvent and the poor solvent used. However, the good solvent content of the porous agent is preferably 50 mass % or more but less than 90 mass %, more preferably 60 mass % or more but 85 mass % or less with respect to the total mass of the porous agent. If the good solvent content is less than 50 mass %, deposited microgels take in the monomer contained in the solvent and finally grow to large microgels, and pores derived from gaps between the large microgels also become large.

It is to be noted that the good solvent is preferably a solvent having a benzene ring, such as trimethyl benzene, toluene, or xylene. This is because due to high compatibility between the benzene ring of the good solvent and the aromatic ring of the copolymer of vinylpyridine and divinylbenzene, the good solvent is uniformly distributed in the framework of the microgels and gaps between the microgels, and therefore a larger number of pores having an appropriate pore diameter can be uniformly distributed, and further the resin can be prevented from having a nonuniform structure so that pulverization and thermal decomposition are less likely to occur.

Examples of the vinylpyridine monomer to be used include, but are not limited to, 2-vinylpyridine, 3-vinylpyridine, 4-vinylpyridine, 4-vinylpyridine derivatives or 2-vinylpyridine derivatives having a lower alkyl group such as a methyl group or an ethyl group on the pyridine ring, 2-methyl-5-vinylpyridine, 2-ethyl-5-vinylpyridine, 3-methyl-5-vinylpyridine, 2,3-dimethyl-5-vinylpyridine, and 2-methyl-3-ethyl-5-vinylpyridine. These monomers may be used singly or in combination of two or more of them.

Examples of the styrene monomer to be used include, but are not limited to, vinylbenzene containing no lower alkyl group such as methyl or ethyl on the benzene ring or containing one or more lower alkyl groups on the benzene ring, 2-methylvinylbenzene, 3-methylvinylbenzene, 4-methylvinylbenzene, 2-ethylvinylbenzene, 3-ethylvinylbenzene, 4-ethylvinylbenzene, 2,3-dimethylvinylbenzene, and 2,4-dimethylvinylbenzene. The ratio between the vinylpyridine monomer and the styrene monomer can be adjusted, if necessary. The number of moles of the styrene monomer is preferably 0 to 5 moles, more preferably 0 to 2 moles per mole of the vinylpyridine monomer.

The cross-linking agent to be used may be a compound having two or more vinyl groups. Examples of such a compound include: aromatic polyvinyl compounds such as divinylbenzene, divinyltoluene, divinylnaphthalene, and trivinylbenzene; aliphatic polyvinyl compounds such as butadiene, diallyl phthalate, ethylene glycol diacrylate, and ethylene glycol dimethacrylate; and polyvinyl-containing nitrogen heterocyclic compounds such as divinylpyridine, trivinylpyridine, divinylquinoline, and divinylisoquinoline. The amount of the cross-linking agent to be used is preferably 10 to 60 parts by mass, more preferably 15 to 35 parts by mass per 100 parts by mass of the monomer.

The polymerization initiator is not particularly limited, and any conventional one used to initiate the reaction of a vinyl compound, such as benzoyl peroxide, lauroyl peroxide, or azobisisobutyronitrile, may be used. The amount of the polymerization initiator to be used is preferably 0.5 to 5.0 parts by mass, more preferably 0.7 to 2.0 parts by mass per 100 parts by mass of a monomer mixture.

It is preferred that the above-described polymerization initiator is used as a main polymerization initiator, and an auxiliary polymerization initiator having a half-life temperature lower than that of the main polymerization initiator is used in combination with the main polymerization initiator. When a reaction temperature comes close to 100° C. due to heat of reaction generated during polymerization of the monomer, a water phase boils so that dispersed oil droplets coalesce. When only the main polymerization initiator is used, an oil phase/water phase ratio needs to be reduced to remove the heat of reaction so that the reaction temperature is controlled to be 100° C. or less. In this case, there is a problem that the amount of the resin obtained per batch is small. On the other hand, when the main polymerization initiator and the auxiliary polymerization initiator are used in combination, a polymerization temperature can be decreased while a polymerization rate is maintained. Therefore, heat of polymerization reaction can be easily removed, which makes it possible to increase an oil phase/water phase ratio and therefore to increase the amount of production per batch.

Examples of such an auxiliary polymerization initiator to be used include 2,2′-azobis(2,4-dimethylvaleronitrile) and 2,2′-azobis(2-methylbutyronitrile). The ratio between the polymerization initiator and the auxiliary polymerization initiator depends on the kinds of polymerization initiator and auxiliary polymerization initiator used, but is, for example, preferably 1:0.2 to 1.0, more preferably 1:0.3 to 0.5 on a mass basis.

The dispersant to be used is not particularly limited, either, and may be a conventional dispersant such as a water-soluble polymer such as polyvinyl alcohol, hydroxyethyl cellulose, carboxymethyl cellulose, sodium polymethacrylate, sodium polyacrylate, starch, gelatin, or an ammonium salt of a styrene/maleic anhydride copolymer or an inorganic salt such as calcium carbonate, calcium sulfate, bentonite, or magnesium silicate.

The surfactant, the radical scavenger, the specific gravity adjuster, and the pH adjuster to be used are not particularly limited, either, and may be any conventional ones. For example, the surfactant to be used may be dodecylbenzenesulfonic acid, the radical scavenger to be used may be sodium nitrite, the specific gravity adjuster to be used may be sodium chlorite, and the pH adjuster to be used may be sodium hydroxide.

Some of the pyridine groups or phenyl groups of the porous pyridine resin particles obtained by the above-described method are quaternized or sulfonated, respectively. This makes it possible to obtain an oil-adsorbing material that can efficiently remove oils from water containing oils as organic components. It is to be noted that the nitrogen atom on a pyridine group is positively charged by quaternization of the pyridine group, and the charged nitrogen atom attracts a water molecule so that hydrophilicity is developed. In the case of quaternization, the porous particles are brought into contact with an alkyl halide such as methyl iodide or ethyl iodide or a hydrohalic acid such as hydriodic acid to quaternize pyridine groups on the surface and in the pores of the pyridine resin particles.

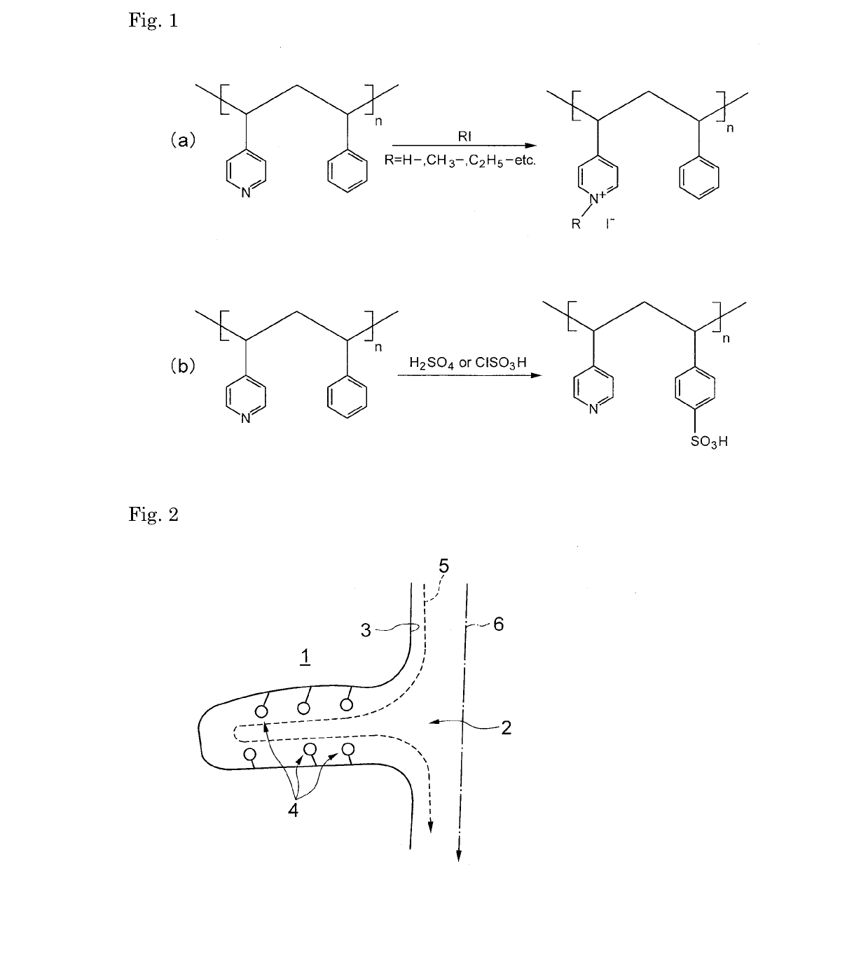

It is to be noted that FIG. 1(a) illustrates a case where a pyridine group that is a typical hydrophobic group is converted to a hydrophilic group by quaternization. In the case of quaternization of pyridine groups, only some of all the pyridine groups are quaternized by adjusting the molar quantity of an alkyl halide or a hydrohalic acid to be brought into contact with the total number of moles of pyridine groups of the porous particles. As a result, some of the pyridine groups that are present not only on the surface but also in the pores of the particles can be converted to hydrophilic groups, and therefore the hydrophilic groups converted from the hydrophobic groups and the hydrophobic groups (lipophilic groups) that are naturally present can coexist not only on the surface but also in the pores of the particles.

On the other hand, in the case of sulfonation, the porous pyridine resin particles obtained by the above-described method are brought into contact with a sulfonating reagent such as concentrated sulfuric acid or chlorosulfonic acid to sulfonate phenyl groups on the surface and in the pores of the pyridine resin particles. As a result, hydrophilic groups converted from the hydrophobic groups can coexist with the hydrophobic groups that are naturally present. It is to be noted that FIG. 1(b) illustrates a case where a phenyl group that is a typical hydrophobic group is converted to a hydrophilic group by sulfonation with concentrated sulfuric acid or chlorosulfonic acid.

Oil-containing water is treated by bringing it into contact with the surface of the oil-adsorbing material. The above-described quaternization or sulfonation makes it possible to convert not only hydrophobic groups on the outer surface of the porous particles but also hydrophobic groups on the wall surface of pores to hydrophilic groups. Therefore, as indicated by the dotted line in FIG. 2, when brought into contact with a surface 3 of a resin 1 as an oil-adsorbing material, oil-containing water to be treated 5 can reach the inside of pores 2 of the resin 1. Heretofore, it is difficult to distribute water to be treated in pores, and as indicated by a long and short dashed line 6, most of water to be treated only flows along the surface of porous particles. However, when hydrophilic groups 4 are introduced onto the wall surface of the pores by quaternization or sulfonation, water to be treated can be brought into contact not only with the surface 3 of the resin 1 but also with the inner surface of the pores 2. As a result, the area of contact between solid and liquid can be increased, which makes it possible to more efficiently perform adsorption treatment of organic components.

As has been described above, the hydrophilicity of the polymer can be controlled by quaternizing some of nitrogen-containing aromatic rings or by sulfonating some of phenyl groups, and therefore adsorption treatment can be performed using porous particles having a good balance between hydrophilicity and hydrophobicity depending on the properties of water to be treated. This makes it possible to efficiently adsorb oils to remove them from oil-containing water.

The porous particles and the water treatment process using the same according to the present invention have been described above with reference to specific examples, but the present invention is not limited to these specific examples, and various embodiments can be made without departing from the scope of the present invention. For example, a method for converting some of hydrophobic groups constituting the porous particles to hydrophilic groups is not limited to substitution typified by quaternization with methyl iodide or the like or sulfonation, and may be introduction of hydrophilic groups such as carboxyl or hydroxyl groups into hydrophobic groups. Further, hydrophobic groups converted to hydrophilic groups are not limited to pyridine groups or phenyl groups, and may be other hydrophobic groups constituting the copolymer resin. Further, the lipophilic resin to which hydrophilicity is imparted is not limited to a pyridine resin, and may be one obtained by mixing a polymer such as polyethylene or polypropylene with castor oil.

### EXAMPLES

First, a cross-linked vinylpyridine resin (CR-1 copolymer resin) was synthesized by suspension polymerization. Specifically, 10 parts by mass of NaCl (specific gravity adjuster), 0.3 parts by mass of NaNO₂ (radical scavenger), 0.064 parts by mass of gelatin (dispersant), and 0.009 parts by mass of sodium dodecylbenzenesulfonate (surfactant) were dissolved in 89.627 parts by mass of ion-exchange water to prepare 6250 g of an aqueous solvent.

At the same time, 36.4 parts by mass of 4-vinylpyridine (vinylpyridine monomer), 43.6 parts by mass of divinylbenzene (purity: 55 mass %) (cross-linking agent), 15 parts by mass of 1,2,4-trimethylbenzene (good solvent), and 5 parts by mass of dioctyl phthalate (poor solvent) were mixed to prepare 3750 g of an oil solvent.

Further, 0.34 parts by mass of 2,2′-azobis (2,4-dimethylvaleronitrile) (auxiliary polymerization initiator) and 0.84 parts by mass of benzoyl peroxide (polymerization agent) were dissolved in 100 parts by mass of the oil solvent. Then, the oil solvent was put into a 10-liter suspension polymerization reactor equipped with a jacket. The aqueous solvent prepared above was supplied from the bottom of the reactor, and the oil solvent and the aqueous solvent were gently stirred until oil droplets were uniformly dispersed.

Then, warm water was flowed through the jacket of the reactor to increase the temperature of the liquid in the reactor to 60° C., and the liquid in the reactor was maintained at this temperature. In the reactor, a polymerization reaction was initiated and gradually progressed so that the temperature of the liquid in the reactor reached a peak of about 80° C. and then decreased to about 60° C. After it was confirmed that the temperature of the liquid in the reactor decreased to 60° C., the liquid in the reactor was heated to 90° C. and maintained as it was for 4 hours. After a lapse of 4 hours, the liquid in the reactor was cooled to ordinary temperature, and was subjected to solid-liquid separation by filtration to collect a resin. The collected resin was further subjected to extraction and washing to remove the porous agents, 1,2,4-trimethylbenzene and dioctyl phthalate, and was then classified using a sieve to obtain a cross-linked 4-vinylpyridine resin. The degree of cross-linking (defined as a weight ratio of the cross-linking agent to all the monomers) of the CR-1 copolymer resin was 30%.

### Reference Example 1

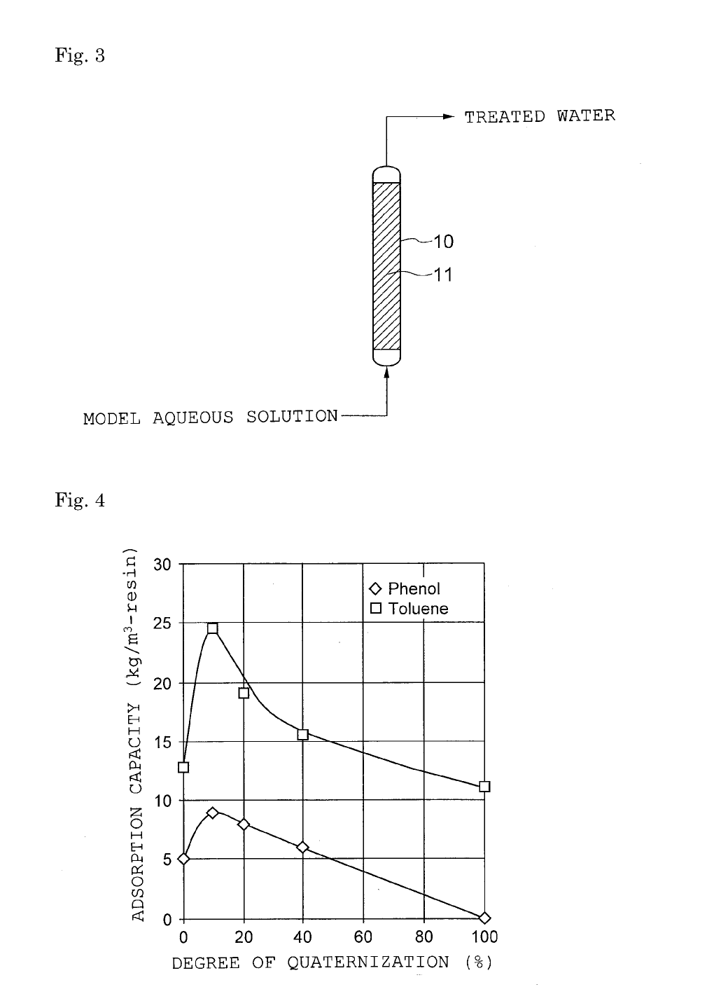

Forty-five milliliters of the CR-1 copolymer resin prepared above was measured using a graduated cylinder and filled in a cylindrical column 10 having an inner diameter of 30 mm and a length of 150 mm, such as one shown in FIG. 3, to prepare an adsorption tower. A model aqueous solution containing 200 ppm by mass of phenol (soluble oil component) and 400 ppm by mass of toluene (insoluble oil component) was supplied from the bottom of the adsorption tower at an LHSV of 16 h⁻¹, and the concentrations of phenol and toluene contained in treated water discharged from the top of the adsorption tower were measured by a gas chromatograph (GC/FID) equipped with a hydrogen flame ionization detector to determine the amounts of phenol and toluene adsorbed to the cross-linked vinylpyridine resin (CR-1). Then, the adsorption capacities of CR-1 per unit volume for phenol and toluene were determined from the adsorbed amounts of phenol and toluene and the volume of a resin 11 filled in the column 10. It is to be noted that a breakthrough point was defined as the point at which the outlet concentration exceeded 1 ppm by mass.

### Example 1

Forty-five milliliters of the CR-1 copolymer resin prepared above was measured using a graduated cylinder. At the same time, 100 mL of a methanol solution was prepared which contained MeI (methyl iodide) in an amount corresponding to 10 mol % of the total number of moles of pyridine groups contained in 45 mL of the CR-1 copolymer resin. This methanol solution was added to 45 mL of the CR-1 copolymer resin, and the mixture was stirred at room temperature for 5 hours to quaternize the CR-1 copolymer resin. The quaternized resin was collected by filtration and washed with 100 mL of water five times. The thus obtained 10% quaternized resin was used to perform an adsorption capacity measuring test in the same manner as in the above Reference Example 1.

### Example 2

The CR-1 copolymer resin was quaternized in the same manner as in the above Example 1 except that MeI was used in an amount corresponding to 20 mol % instead of 10 mol % of the total number of moles of pyridine groups contained in 45 mL of the CR-1 copolymer resin. The thus obtained 20% quaternized resin was used to perform an adsorption capacity measuring test in the same manner as in the above Reference Example 1.

### Example 3

The CR-1 copolymer resin was quaternized in the same manner as in the above Example 1 except that MeI was used in an amount corresponding to 40 mol % instead of 10 mol % of the total number of moles of pyridine groups contained in 45 mL of the CR-1 copolymer resin. The thus obtained 40% quaternized resin was used to perform an adsorption capacity measuring test in the same manner as in the above Reference Example 1.

### Reference Example 2

The CR-1 copolymer resin was quaternized in the same manner as in the above Example 1 except that MeI was used in an amount corresponding to 100 mol % instead of 10 mol % of the total number of moles of pyridine groups contained in 45 mL of the CR-1 copolymer resin. The thus obtained 100% quaternized resin was used to perform an adsorption capacity measuring test in the same manner as in the above Reference Example 1.

### Comparative Example

An adsorption capacity measuring test was performed in the same manner as in Reference Example 1 except that a commercially-available styrene-based anion-exchange resin with amine groups, Amberlite 96SB was used instead of the CR-1 copolymer resin. The results of the test were shown in the following Table 1 together with the results of the above Reference Examples 1 and 2 and Examples 1 to 3.

TABLE 1

| | | | | | Adsorption | |
|---|---|---|---|---|---|---|
| | | | Adsorbed | | Capacity | |
| | Adsorbent | | Amount (g) | | (kg/m³) | |
| | | Mass | | Tolu- | Phe- | Tolu- |
| | Name of Resin | (dry g) | Phenol | ene | nol | ene |
| Reference | 0% quaternized | 20.3 | 0.22 | 0.58 | 5 | 13 |
| Example 1 | CR-1 | | | | | |
| Example 1 | 10% quaternized | 21.5 | 0.42 | 1.10 | 9 | 24 |
| | CR-1 | | | | | |
| Example 2 | 20% quaternized | 22.8 | 0.36 | 0.86 | 8 | 19 |
| | CR-1 | | | | | |
| Example 3 | 40% quaternized | 25.3 | 0.28 | 0.70 | 6 | 16 |
| | CR-1 | | | | | |
| Reference | 100% quaternized | 32.9 | 0 | 0.50 | 0 | 11 |
| Example 2 | CR-1 | | | | | |
| Comparative | Amberlite SB96 | 22.5 | 0.08 | 0.08 | 2 | 2 |
| Example | | | | | | |

The results were plotted in FIG. 4 to see the effect of the degree of quaternization of the CR-1 copolymer resin on adsorption capacities for phenol and toluene. As can be seen from FIG. 4, adsorption capacities for phenol and toluene both increased as the degree of quaternization of pyridine groups increased from 0%, and the 10% quaternized resin showed the maximum adsorption capacities. When the degree of quaternization further increased, both the adsorption capacities decreased. In the case of the 100% quaternized resin, its ability to adsorb phenol was almost zero. From the result, pyridine groups can be assumed to be adsorption sites for phenol.

It is to be noted that the inflection point of a curve representing the adsorption capacity for toluene is around a point where the degree of quaternization is 40%, and the adsorption capacity for toluene at this point is almost equal to that when the degree of quaternization is 5%. That is, both phenol and toluene can be efficiently adsorbed by converting 5% or more but 40% or less of all the pyridine groups to hydrophilic groups. In these examples, some of pyridine groups were converted to hydrophilic groups. However, it can be assumed that the same effect can be obtained also when some of aromatic rings other than pyridine groups are converted to hydrophilic groups by sulfonation or the like. In other words, both phenol and toluene can be efficiently adsorbed by using a resin whose ratio of the number of moles of hydrophilic groups is adjusted to 5.3 moles ((5/95)×100) or more but 67 moles ((40/60)×100) or less per 100 moles of hydrophobic groups.

The above-described relationship between the degree of quaternization and the adsorption capacity is interpreted as follows. When pyridine groups are quaternized, pyridinium cations are generated so that the hydrophilicity of the resin increases, and therefore it is considered that water easily enters pores inside the resin and can come into contact with adsorption sites inside the resin. However, when the degree of quaternization increases, the number of adsorption sites for phenol decreases so that the adsorption capacity for phenol naturally decreases. Also, it is assumed that when the hydrophilicity of the resin increases, interaction with hydrophobic toluene adversely becomes weak so that the adsorption capacity for toluene also decreases.

### Example 4

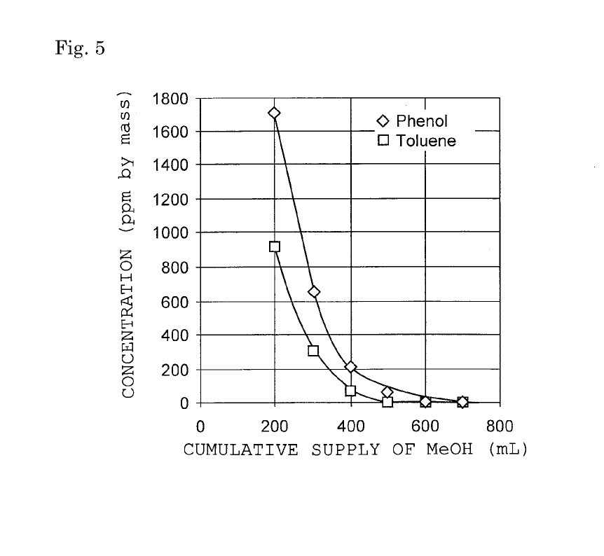

The 10% quaternized CR-1 copolymer resin that adsorbed phenol and toluene until breakthrough occurred in Example 1 was regenerated by passing methanol as a regenerating solution through it at an LHSV of 4 h⁻¹ while the concentrations of phenol and toluene in effluent at the outlet were measured. As a result, as shown in FIG. 5, both the concentrations of phenol and toluene could be decreased to 1 ppm by mass or less when a cumulative amount of methanol passed through the CR-1 copolymer resin was 700 mL. In this way, it was confirmed that the CR-1 copolymer resin could be regenerated with a lower alcohol at room temperature.

### REFERENCE SIGNS LIST

1 Resin
2 Pore
3 Resin surface
4 Hydrophilic group
5 Flow of water to be treated
6 Conventional flow of water to be treated
10 Adsorption tower
11 Resin

1. A method for treating oil-containing water, comprising the steps of:
preparing an oil-adsorbing material that is made of a lipophilic resin and that has many pores in its surface and bears hydrophilic groups on an inner surface of the pores; and
bringing oil-containing water into contact with the surface of the oil-adsorbing material.

2. The method for treating oil-containing water according to claim 1, wherein the step of preparing the oil-adsorbing material includes the step of converting some of hydrophobic groups on the inner surface of the pores to hydrophilic groups.

3. The method for treating oil-containing water according to claim 1, wherein the hydrophilic groups are quaternized amine or sulfonic acid.

4. The method for treating oil-containing water according to claim 2, wherein the hydrophobic groups are nitrogen-containing aromatic rings.

5. The method for treating oil-containing water according to claim 2, wherein the step of converting to hydrophilic groups is performed by bringing the resin into contact with an alkyl halide or a hydrohalic acid to quaternize some of nitrogen-containing aromatic rings.

6. The method for treating oil-containing water according to claim 2, wherein the step of converting to hydrophilic groups is performed by bringing the resin into contact with concentrated sulfuric acid or chlorosulfonic acid to sulfonate some of aromatic rings.

7. The method for treating oil-containing water according to claim 1 wherein the oil-adsorbing material is regenerated using a lower alcohol.

8. A method for treating oil-containing water, comprising the steps of:
preparing porous particles that are made of lipophilic resin having hydrophobic groups and that have many pores in their surface and;
converting 5% or more but 40% or less of all the hydrophobic groups to hydrophilic groups to introduce hydrophilic groups onto an inner surface of the pores; and
bringing oil-containing water into contact with the surface of the porous particles.

9. Porous particles that are made of lipophilic resin and that have many pores in their surface, the porous particles having hydrophilic groups on an inner surface of the pores.

10. The porous particles according to claim 9, wherein the hydrophilic groups are quaternized amine or sulfonic acid.

11. The porous particles according to claim 9, wherein the resin has nitrogen-containing aromatic rings.

12. The porous particles according to claim 9, wherein the resin is a pyridine resin.

13. The porous particles according to claim 9, wherein the resin has a cross-linked structure.

14. Porous particles that are made of lipophilic resin and that have many pores in their surface, wherein the resin has hydrophobic groups and hydrophilic groups, and a ratio of the hydrophilic groups is 5.3 moles or more but 67 moles or less per 100 moles of the hydrophobic groups, the porous particles having hydrophilic groups on an inner surface of the pores.

15. The method for treating oil-containing water according to claim 2, wherein the hydrophilic groups are quaternized amine or sulfonic acid.

16. The method for treating oil-containing water according to claim 2 wherein the oil-adsorbing material is regenerated using a lower alcohol.

17. The method for treating oil-containing water according to claim 3 wherein the oil-adsorbing material is regenerated using a lower alcohol.

18. The porous particles according to claim 10, wherein the resin is a pyridine resin.

19. The porous particles according to claim 11, wherein the resin is a pyridine resin.

20. The porous particles according to claim 10, wherein the resin has a cross-linked structure.
